(19) United States
(12) Patent Application Publication
(10) Pub. No.: US 2012/0094831 A1
(43) Pub. Date: Apr. 19, 2012

(54) Chlorella Cells as a Method for Improving Plant Quality

(75) Inventor: Gregory Keith Bartley, JR., Knoxville, TN (US)

(73) Assignee: Gregory Keith Bartley, JR., Knoxville, TN (US)

(21) Appl. No.: 13/235,464

(22) Filed: Sep. 18, 2011

Related U.S. Application Data
(60) Provisional application No. 61/455,201, filed on Oct. 18, 2010.

(51) Int. Cl. A01N 63/02; A01P 3/00; A01P 7/04; A01P 7/02; A01P 21/00

(52) U.S. Cl. 504/101; 504/117

(57) ABSTRACT

This invention relates to a method of improving plant quality through the foliar application of Chlorella cells to the plant. The composition consists of an effective amount of biomass obtained from Chlorella cells.

### BACKGROUND INFORMATION

The present invention relates to methods of improving the quality, health, and/or color of plants, and of alleviating stress and stress responses experienced by living plant tissue.

Chlorella, a genus of single-celled green algae, is considered the most photosynthetically efficient organism in the world. Chlorella's chlorophyll content can reach levels as high as 8%; approximately 16 times more than most green foods. Chlorella conducts photosynthesis through the absorption of sunlight by chlorophyll-a, chlorophyll-b, and carotenoid pigments located in its chloroplast.

It has now been recognized that the quality, health, and/or color of plants can be improved through the application of effective amounts of particulate biomass that has been obtained from the cell tissue of Chlorella species. Effective application rates of this solution are subjective to the proposed level of effectiveness for reducing the amount of stress presently putting the plant at risk for senescence and/or death.

### INVENTION SUMMARY

The present invention provides a method of improving or altering plant quality, health, or color comprising applying an effective amount of a composition containing biomass from Chlorella cell tissue to the surface of living plant tissue, with the proviso that the composition does not include any additional components other than what can be naturally obtained from Chlorella tissue.

The present invention further provides a composition for improving or altering plant quality, health, or color consisting essentially of an effective amount of plant-improving Chlorella biomass, at least one dispersant acceptable for use on plants, at least one carrier acceptable for use on plants, and, optionally, water.

### DESCRIPTION OF DRAWINGS

FIG. 1 illustrates the absorption spectra of total pigment extracts in Chlorella.

FIG. 2 illustrates the presence of plant-harmful UV-B radiation on both normal and cloudy days.

TAB. 1 illustrates the ANOVA (Analysis of Variance) in plots prior to the initiation of treatments.

TAB. 2 illustrates the ANOVA in plots 2 WAIT (Weeks After Initiation of Treatments).

TAB. 3 illustrates the ANOVA in plots 4 WAIT.

TAB. 4 illustrates the ANOVA in plots 6 WAIT.

### DETAILED INVENTION DESCRIPTION

Chlorella extracts suitable for use, according to the invention, include any pigment, dye, particulate biomass, fragmented biomass, or tissue component obtainable from Chlorella cell structures.

The compositions used according to the invention preferably consist essentially of an effective amount of a Chlorella cell biomass and more preferably consist of an effective amount of pigment, colorant, dye construct, fragments, and/or particles from Chlorella cell biomass, at least one dispersant, at least one carrier, and, optionally, water. The compositions may in one embodiment contain cell biomass and water with no carrier. The compositions of the invention may consist essentially of Chlorella cell biomass and water. The compositions may also consist of a Chlorella extract or other cell derived compound and water.

By “carrier” there is meant herein an organic or inorganic material, which can be natural or synthetic and which is associated with the Chlorella cell biomass and facilitates its application to the surface of the plant. This carrier is thus generally inert and should be environmentally acceptable for use on the proposed plant. The carrier can be solid (e.g., clay, silicates, silica, resins, wax, fertilizers, or the like) or liquid (e.g., water, alcohols, ketones, oil solvents, saturated or unsaturated hydrocarbons, chlorinated hydrocarbons, liquefied petroleum gas, or the like).

Among the many optional additives suitable for use in compositions of the invention include surfactants and other ingredients, such as dispersants, stickers, antifoam agents, anti-freezing agents, dyestuffs, thickeners, adhesives, protective colloids, penetrating agents, stabilizing agents, sequestering agents, anti-flocculating agents, corrosion inhibitors, pigments (other than those contemplated as an active ingredient for purposes of the invention), and polymers.

More generally, the compositions of the invention can include all kinds of solid or liquid additives which are known in the art of crop protection and horticultural pest control treatments.

The surfactants can be of the emulsifying or wetting type and can be ionic or non-ionic. Possible surfactants are salts of polyacrylic or lignosulfonic acids; salts of phenolsulfonic or naphthalenesulfonic acids; polycondensates of ethylene oxide with fatty alcohols or fatty acids or fatty amines or substituted phenols (particularly alkylphenols or arylphenols); ester-salts of sulfosuccinic acids; taurine derivatives, such as alkyl taurates; phosphoric esters; or esters of alcohols or polyoxyethylated phenols. When the spraying vehicle is water, the use of at least one surfactant is generally required because the active ingredients may not be completely water-soluble.

Dusting powders, granulates, solutions, emulsifiable concentrates, emulsions, suspended concentrates and aerosols are also contemplated within the invention. The compositions according to the invention can contain other ingredients, for example protective colloids, adhesives or thickeners, thixotropic agents, stabilizers or sequestrants, as well as other active materials known to have pesticidal properties, especially certain fungicides, acaricides, and insecticides.

The present invention can be practiced on all plants, including those used for agricultural, ecological, or ornamental purposes.

The compositions of the invention are applied by known methods.

The following examples further illustrate details for the applicable nature of this invention. The invention applicability, which is set forth in the foregoing disclosure, is not to be limited either in spirit or scope by these reasons. Those skilled in the art will readily understand that known variations of the conditions of the following figures can be referenced.

### BRIEF DESCRIPTION OF FIGURES

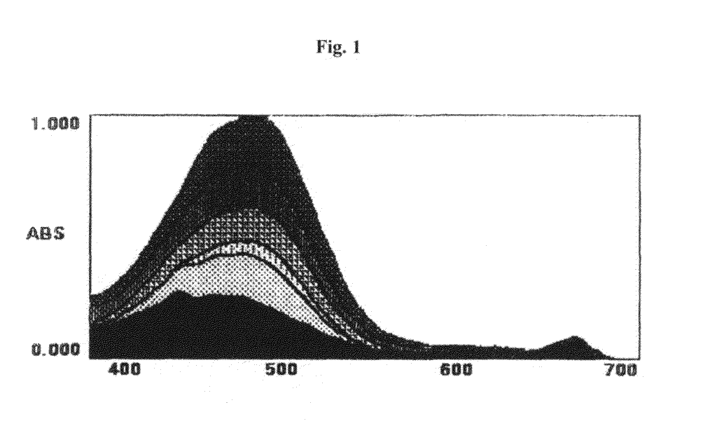

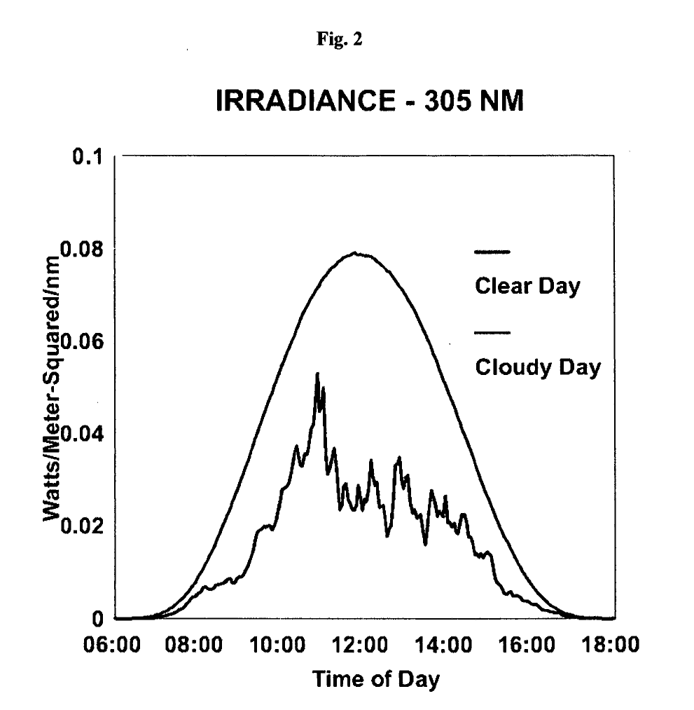

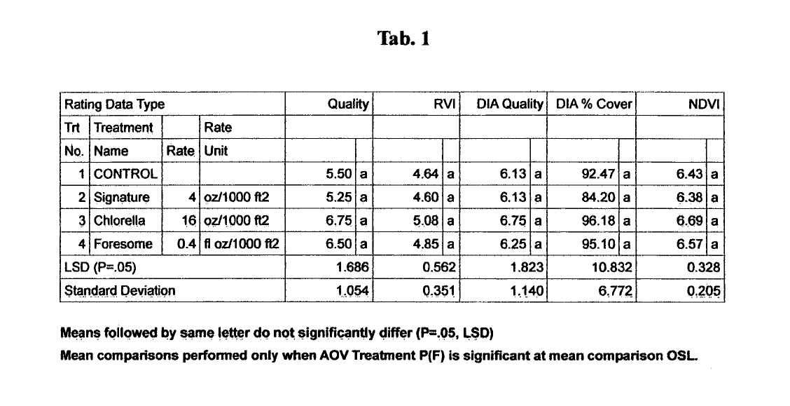

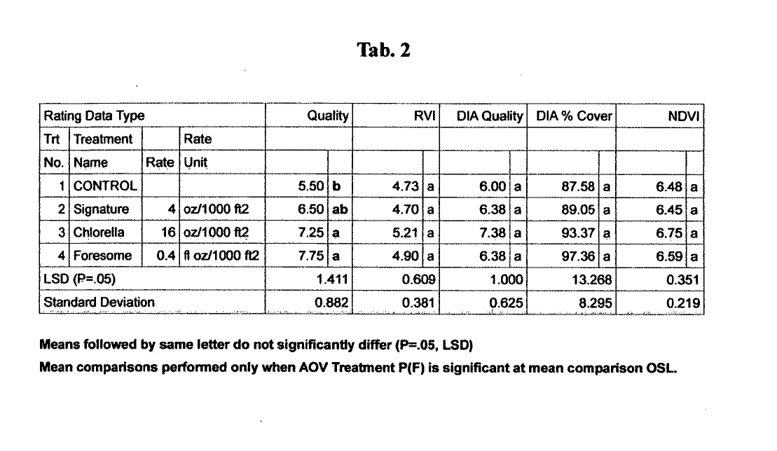

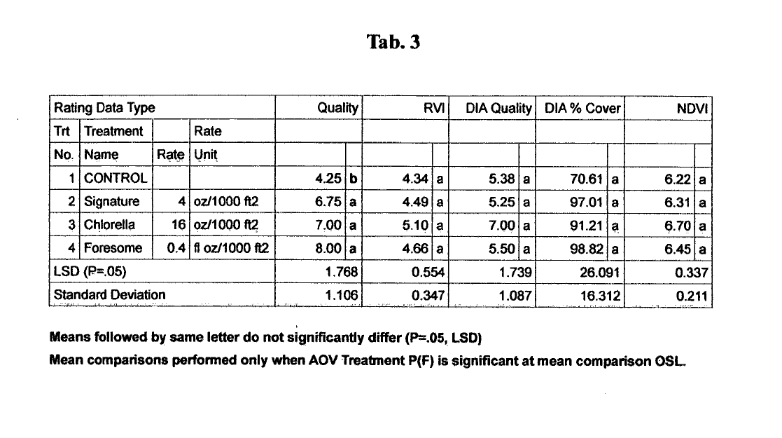

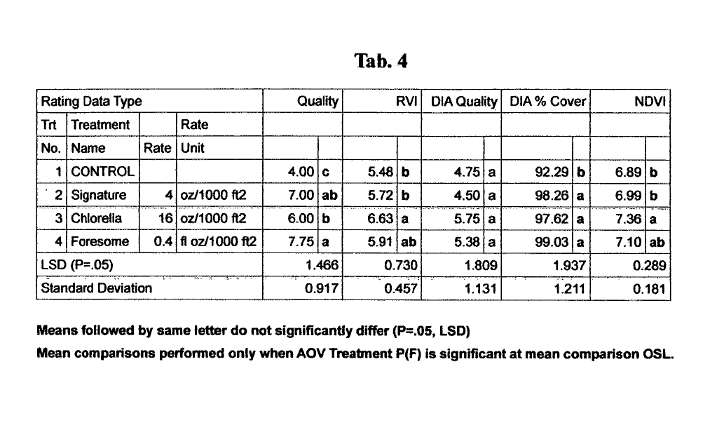

FIG. 1 illustrates the absorbance spectrum of the total range of pigments found in cells of Chlorella. This figure further illustrates the high affinity of these pigment molecules for the absorption of harmful UV radiation. These applied proficiencies contrast the negative plant health effects associated with the direct absorbance of harmful UV-B radiation (See FIG. 2).

FIG. 2 illustrates the presence of plant-harmful UV-B radiation throughout the day. Effects of this exposure to UV-B radiation include, but are not limited to: increased sensitivity of plant photosystems to visible light; chloroplast membrane degradation; chlorophyll destruction; loss in stomatal function; reduction in leaf area and expansion; loss in color; reduced reflectance of NIR wavelengths of light, causing a buildup of heat; increases in the mesophyll resistance to carbon dioxide uptake; and substantial reductions in plant biomass and yield.

### EXAMPLES

### Example 1

The following test methods were used to compare the effectiveness of the method according to the invention with known methods. The following compositions were used in the experiments: Pulverized Cells of Chlorella was used alone. The commercially available product Chipco® Signature™ fungicide from Bayer Environmental Science, Montvale, N.J. was used alone. The commercially available product Foursome™ Turf Pigment from Quali-Pro, Raleigh, N.C. was used alone.

The experiment was conducted during the summer of 2011 on a previously established, mixed variety, creeping bentgrass putting green constructed with a USGA (United States Golf Association) specification sand-based root-zone. Plants were maintained under golf course conditions and mown daily at a height of 0.125 inches using a reel mower. Plants were watered daily using overhead irrigation, and fertilized with Urea Nitrogen (46-0-0) at 0.25 lbs./1000 ft² once a month during the growing season.

Pulverized cells of Chlorella were submersed alone in a water carrier vehicle and applied to the foliage every 4 days at a rate of 16 oz./1000 ft². Signature™ fungicide was submersed alone in a water carrier vehicle and applied weekly at a rate of 4 oz./1000 ft². Foursome™ Turf Pigment was submersed alone in a water carrier vehicle and applied weekly at a rate of 0.4 fl. oz./1000 ft². Water alone was used as an untreated control. All treatments were applied using a CO₂ pressurized hand-held boom sprayer calibrated to deliver 2 gal/1000 ft². Plots were arranged in a Randomized Complete Block Design. Each Treatment had 4 replications.

Turf quality was visually rated on a scale from 0 to 9 according to the density, greenness, and uniformity of the plants, with 0 being the worst and 9 being the best.

Canopy reflectance was measured using a Crop Circle™ model ACS-470 spectrophotometer from Holland Scientific, Lincoln, Nebr. It was calibrated and configured for use with filters 650-40, 760/LWP, and 550-40 set for channels 1, 2, and 3 respectively. Obtained reflectance values were used to calculate NDVI (Normalized Difference Vegetation Index) and RVI (Ratio Vegetation Index). Obtained NDVI and RVI values were multiplied by a factor of 10 in order to denote a rating scale from 1-10.

DIA (Digital Image Analysis) was conducted using still pictures from a Powershot G-12 Camera from Canon U.S.A., Lake Success, N.Y. The camera was calibrated for use in a light box. The light box was equipped with 6500 Kelvin Color Temperature LEDs (light-emitting diodes). In order to obtain values of DIA % Cover and DIA Quality, the light box pictures were analyzed using SigmaScan Pro 5 from SPSS, Chicago, Ill. according to methods described by (Richardson, Karcher, & Purcell, 2001).

A base set of data was taken on the plots prior to the first application of treatments. Data measurements were taken on a biweekly basis following the first treatment date.

All Data were subjected to ANOVA and means separation by Least Significant Difference method (p=0.05).

### Test Results

### A. Visual Quality

TAB. 1 illustrates the absence of significant differences among the visual quality means of plots prior to the initiation of treatments.

TAB. 2 illustrates the significantly greater visual quality of Chlorella and Foursome treatments over that of the Control 2 WAIT.

TAB. 3 illustrates the significantly greater visual quality means of Signature, Chlorella, and Foursome over that of the Control 4 WAIT.

TAB. 4 illustrates the significantly greater visual quality means of Signature, Chlorella, and Foursome over that of the Control 6 WAIT.

### B. Canopy Reflectance (NDVI & RVI)

TAB. 1 illustrates the absence of significant differences among the NDVI and RVI means of plots prior to the initiation of treatments.

TAB. 4 illustrates the significantly greater NDVI and RVI means of Chlorella over that of Signature, Foursome, and the Control 6 WAIT.

### C. Digital Image Analysis (DIA % Cover & DIA Quality)

TAB. 1 illustrates the absence of significant differences among the DIA % Cover & DIA Quality means of plots prior to the initiation of treatments.

TAB. 4 illustrates the significantly greater DIA % Cover means of Signature, Chlorella, and Foursome over that of the Control 6 WAIT.

TABLE 1

| Rating Data Type | | | | | | | | |
|---|---|---|---|---|---|---|---|---|
| Trt | Treatment | | Rate | | | DIA | DIA % | |
| No. | Name | Rate | Unit | Quality | RVI | Quality | Cover | NDVI |
| 1 | CONTROL | | | 5.50 a | 4.64 a | 6.13 a | 92.47 a | 6.43 a |
| 2 | Signature | 4 | oz/1000 ft2 | 5.25 a | 4.60 a | 6.13 a | 84.20 a | 6.38 a |
| 3 | Chlorella | 16 | oz/1000 ft2 | 6.75 a | 5.08 a | 6.75 a | 96.18 a | 6.69 a |
| 4 | Foresome | 0.4 | fl oz/1000 ft2 | 6.50 a | 4.85 a | 6.25 a | 95.10 a | 6.57 a |

| | | | | | |
|---|---|---|---|---|---|
| LSD (P = .05) | 1.686 | 0.562 | 1.823 | 10.832 | 0.328 |
| Standard Deviation | 1.054 | 0.351 | 1.140 | 6.772 | 0.205 |

Means followed by same letter do not significantly differ (P = .05, LSD)
Mean comparisons performed only when AOV Treatment P(F) is significant at mean comparison OSL.

TABLE 2

| Rating Data Type | | | | | | | | |
|---|---|---|---|---|---|---|---|---|
| Trt | Treatment | | Rate | | | DIA | DIA % | |
| No. | Name | Rate | Unit | Quality | RVI | Quality | Cover | NDVI |
| 1 | CONTROL | | | 5.50 b | 4.73 a | 6.00 a | 87.58 a | 6.48 a |
| 2 | Signature | 4 | oz/1000 ft2 | 6.50 ab | 4.70 a | 6.38 a | 89.05 a | 6.45 a |
| 3 | Chlorella | 16 | oz/1000 ft2 | 7.25 a | 5.21 a | 7.38 a | 93.37 a | 6.75 a |
| 4 | Foresome | 0.4 | fl oz/1000 ft2 | 7.75 a | 4.90 a | 6.38 a | 97.36 a | 6.59 a |

| | | | | | |
|---|---|---|---|---|---|
| LSD (P = .05) | 1.411 | 0.609 | 1.000 | 13.268 | 0.351 |
| Standard Deviation | 0.882 | 0.381 | 0.625 | 8.295 | 0.219 |

Means followed by same letter do not significantly differ (P = .05, LSD)
Mean comparisons performed only when AOV Treatment P(F) is significant at mean comparison OSL.

TABLE 3

| Rating Data Type | | | | | | | | |
|---|---|---|---|---|---|---|---|---|
| Trt | Treatment | | Rate | | | DIA | DIA % | |
| No. | Name | Rate | Unit | Quality | RVI | Quality | Cover | NDVI |
| 1 | CONTROL | | | 4.25 b | 4.34 a | 5.38 a | 70.61 a | 6.22 a |
| 2 | Signature | 4 | oz/1000 ft2 | 6.75 a | 4.49 a | 5.25 a | 97.01 a | 6.31 a |
| 3 | Chlorella | 16 | oz/1000 ft2 | 7.00 a | 5.10 a | 7.00 a | 91.21 a | 6.70 a |
| 4 | Foresome | 0.4 | fl oz/1000 ft2 | 8.00 a | 4.66 a | 5.50 a | 98.82 a | 6.45 a |

| | | | | | |
|---|---|---|---|---|---|
| LSD (P = .05) | 1.768 | 0.554 | 1.739 | 26.091 | 0.337 |
| Standard Deviation | 1.106 | 0.347 | 1.087 | 16.312 | 0.211 |

Means followed by same letter do not significantly differ (P = .05, LSD)
Mean comparisons performed only when AOV Treatment P(F) is significant at mean comparison OSL.

TABLE 4

| Rating Data Type | | | | | | | | |
|---|---|---|---|---|---|---|---|---|
| Trt | Treatment | | Rate | | | DIA | DIA % | |
| No. | Name | Rate | Unit | Quality | RVI | Quality | Cover | NDVI |
| 1 | CONTROL | | | 4.00 c | 5.48 b | 4.75 a | 92.29 b | 6.89 b |
| 2 | Signature | 4 | oz/1000 ft2 | 7.00 ab | 5.72 b | 4.50 a | 98.26 a | 6.99 b |
| 3 | Chlorella | 16 | oz/1000 ft2 | 6.00 b | 6.63 a | 5.75 a | 97.62 a | 7.36 a |
| 4 | Foresome | 0.4 | fl oz/1000 ft2 | 7.75 a | 5.91 ab | 5.38 a | 99.03 a | 7.10 ab |

| | | | | | |
|---|---|---|---|---|---|
| LSD (P = .05) | 1.466 | 0.730 | 1.809 | 1.937 | 0.289 |
| Standard Deviation | 0.917 | 0.457 | 1.131 | 1.211 | 0.181 |

Means followed by same letter do not significantly differ (P = .05, LSD)
Mean comparisons performed only when AOV Treatment P(F) is significant at mean comparison OSL.

1. A method of improving or altering a growing medium and/or plant such to alter or improve the quality, health, fertility, and/or aesthetic appearance or color of said growing medium and/or plant comprising applying an effective amount of a composition containing Chlorella cells or cell biomass to said plant and/or growing medium, with the proviso that the active composition not include any additional components other than that which can be obtained from Chlorella cell biomass or tissue.

2. A method of improving or altering a growing medium and/or plant such to alter or improve the quality, health, fertility, and/or aesthetic appearance or color of said growing medium and/or plant comprising applying, to a plant and/or growing medium, an effective amount of a composition consisting of Chlorella cells, cell tissue, or cell biomass, at least one dispersant, and at least one carrier.

3. A method of improving or altering a growing medium and/or plant such to alter or improve the quality, health, fertility, and/or aesthetic appearance or color of said growing medium and/or plant comprising applying, to a plant and/or growing medium, an effective amount of a composition consisting of Chlorella cells, cell tissue, or cell biomass and water to a plant.

4. A composition for improving or altering a growing medium and/or plant such to alter or improve the quality, health, fertility, and/or aesthetic appearance or color of said growing medium and/or plant consisting essentially of an effective plant- or growing medium-altering amount of Chlorella cells, cell tissue, or cell biomass, at least one dispersant acceptable for use with plants, at least one carrier acceptable for use with plants, and optionally water.

5. A composition for improving or altering a growing medium and/or plant such to alter or improve the quality, health, fertility, and/or aesthetic appearance or color of said growing medium and/or plant consisting of an effective plant- or growing medium-altering amount of a Chlorella cells, cell tissue, or cell biomass fragments, particles, pigments, colorants, dye components, or any other piece of matter obtainable from Chlorella cells through known means, at least one dispersant acceptable for use with plants, at least one carrier acceptable for use with plants, and optionally water.

6. A composition for improving or altering a growing medium and/or plant such to alter or improve the quality, health, fertility, and/or aesthetic appearance or color of said growing medium and/or plant consisting of an effective plant- or growing medium-altering amount of Chlorella cells, cell tissue, or cell biomass and water.

7. A wettable powder composition for improving or altering a growing medium and/or plant such to alter or improve the quality, health, fertility, and/or aesthetic appearance or color of said growing medium and/or plant consisting of an effective plant- or growing medium-altering amount of Chlorella cells, cell tissue, or cell biomass.

8. A liquid composition for improving or altering a growing medium and/or plant such to alter or improve the quality, health, fertility, and/or aesthetic appearance or color of said growing medium and/or plant consisting of an effective plant- or growing medium-altering amount of Chlorella cells, cell tissue, or cell biomass.

9. A liquid or granular composition for marking, painting, decorating, or denoting location on a plant, growing medium, and/or landscape comprised of living and/or dead plants, such to directly or indirectly improve or alter the quality, health, fertility, and/or aesthetic appearance or color of said growing medium and/or plant consisting essentially of an effective plant- or growing medium-altering amount of Chlorella cells, cell tissue, or cell biomass.

10. A composition according to claims 1, 2, 3, 4, 5, 6, 7, 8, and 9 wherein the growing medium for which is intended application is a soil, hydroponic pool, or other medium commonly used for which to influence or encourage the growth, production, or maintenance of a plant.

11. A composition according to claims 1, 2, 3, 4, 5, 6, 7, 8, and 9 wherein the biomass is a pigment, colorant, or dye construct.

12. A composition according to claims 1, 2, 3, 4, 5, 6, 7, 8, and 9 wherein the biomass is a fragment, particle, or any other piece of matter obtainable from the cell through known means.

13. A composition according to claims 1, 2, 3, 4, 5, 6, 7, 8, and 9 additionally comprising one or more fungicides, fertilizers, acaricides, turf markers, turf pigments, and/or insecticides.
